(19) United States
(12) Patent Application Publication
(10) Pub. No.: US 2025/0168134 A1
(43) Pub. Date: May 22, 2025

(54) METHOD OF INFORMATION PROCESSING, ELECTRONIC DEVICE AND STORAGE MEDIUM

(71) Applicant: Beijing Zitiao Network Technology Co., Ltd., Beijing (CN)

(72) Inventors: Yizhe YANG, Beijing (CN); Liuyuan Yu, Beijing (CN); Jinjie Zhang, Beijing (CN); Jiahe Ma, Beijing (CN); Changsheng Wang, Beijing (CN); Zhenyu Zhao, Beijing (CN); Haitao Jia, Beijing (CN); Chong Niu, Beijing (CN)

(21) Appl. No.: 18/952,572

(22) Filed: Nov. 19, 2024

(30) Foreign Application Priority Data
Nov. 21, 2023 (CN) 202311559410.5

(51) Int. Cl. H04L 51/02; G06F 40/30

(52) U.S. Cl. CPC H04L 51/02; G06F 40/30

(57) ABSTRACT

A method of information processing, an electronic device and a storage medium are provided. The method includes generating a first message based on information indicated by a trigger request from a client of the digital assistant under a first task topic in response to the trigger request; sending the first message to a second server to cause the second server to process the trigger request under the first task topic, the second server being a creator of the first task topic; and receiving a second message returned by the second server and sending the second message to the client of the digital assistant.

### CROSS-REFERENCE TO RELATED APPLICATION

The present disclosure claims priority of the Chinese Patent Application No. 202311559410.5 filed on Nov. 21, 2023, the disclosure of which is incorporated herein by reference in its entirety as part of the present disclosure.

### TECHNICAL FIELD

The present disclosure relates to a method of information processing, an electronic device and a computer-readable storage medium.

### BACKGROUND

With the rapid development of a computer technology, digital assistants came into being. The digital assistant usually has natural language processing capability. A user can interact with the digital assistant through a man-machine dialogue.

Specifically, the user can send request information through a client of the digital assistant, and a server of the digital assistant processes the request information, generates reply information, and returns the reply information to the client of the digital assistant, thus realizing the man-machine dialogue.

### SUMMARY

The present disclosure provides a method of information processing. This method supports the client to realize the man-machine dialogue under a task topic created by an external server, so as to meet diversified man-machine dialogue needs of users. The present disclosure also provides a system corresponding to the method, an electronic device, a non-transitory computer-readable storage medium and a computer program product.

The present disclosure provides a method of information processing, applied to a first server of a digital assistant, the method including:
generating a first message based on information indicated by a trigger request from a client of the digital assistant under a first task topic in response to the trigger request;
sending the first message to a second server to cause the second server to process the trigger request under the first task topic, the second server being a creator of the first task topic; and
receiving a second message returned by the second server and sending the second message to the client of the digital assistant.

The present disclosure provides a system of information processing, including:
a generation module configured to generate a first message based on information indicated by a trigger request from a client of the digital assistant under a first task topic in response to the trigger request; and
a communication module configured to send the first message to a second server to cause the second server to process the trigger request under the first task topic, the second server being a creator of the first task topic,
the communication module also being configured to receive a second message returned by the second server and send the second message to the client of the digital assistant.

The present disclosure provides an electronic device. The electronic device includes a processor and a memory. The processor and the memory communicate with each other. The processor is configured to execute instructions stored in the memory, so as to cause the electronic device to execute the method of information processing described in the above or any one of the implementations of the above.

The present disclosure provides a non-transitory computer-readable storage medium having stored therein instructions which instruct the electronic device to execute the method of information processing described in the above or any one of the implementations of the above.

The present disclosure provides a computer program product including instructions which, when run on an electronic device, cause the electronic device to execute the method of information processing described in the above or any one of the implementations of the above.

On the basis of the implementations provided by the above of the present disclosure, further combination can be performed to provide more implementations.

### BRIEF DESCRIPTION OF DRAWINGS

In order to explain technical methods of embodiments of the present disclosure more clearly, the drawings needed in the embodiments will be briefly introduced below.

FIG. 1 is a schematic diagram about a task topic provided by an embodiment of the present disclosure;

FIG. 2 is a schematic diagram of a dialogue under a task topic provided by an embodiment of the present disclosure;

FIG. 3 is an architectural schematic diagram of a system of information processing provided by an embodiment of the present disclosure;

FIG. 4 is a flow diagram of a method of information processing provided by an embodiment of the present disclosure;

FIG. 5 is a structural schematic diagram of a system of information processing provided by an embodiment of the present disclosure; and

FIG. 6 is a structural schematic diagram of an electronic device provided by an embodiment of the present disclosure.

### DETAILED DESCRIPTION

The terms “first”, “second” in the embodiments of the present disclosure are used for descriptive purposes only and are not to be construed as indicating or implying relative importance or to implicitly indicate the number of technical features indicated. Therefore, the features defined as “first” and “second” may include one or more of these features explicitly or implicitly.

Some technical terms referred to in the embodiments of the present disclosure will be first described.

A digital assistant, also known as a dialogue robot or a chat robot, usually has a natural language processing capability. A user can interact with the digital assistant through a man-machine dialogue.

In the present disclosure, a concept of a task topic is put forward. The task topic, also known as a dialogue scene, can be understood as a topic of the man-machine dialogue between the user and the digital assistant. The digital assistant may provide multiple task topics, and the user can select one of the task topics according to actual needs and starts a dialogue under the task topic. The above-mentioned man-machine dialogue under the specific task topic is also called a scene dialogue.

One task topic is configured with corresponding configuration information to execute a corresponding type of task, and the configuration information may include at least one selected from the group consisting of: task topic setting information and plug-in information. The task topic setting information is used for describing information related to the corresponding task topic, and the plug-in information indicates at least one plug-in configured to execute a task under the corresponding task topic.

In some embodiments, the task topic setting information can be used to construct a prompt input for the language model used under the corresponding task topic. At this time, the reply information for the user can be determined based on an output of the language model. The task topic setting information may include at least one selected from the group consisting of: description of the corresponding type of task, a reply style of the digital assistant under the task topic, a definition of a workflow to be executed under the corresponding task topic, or a definition of a reply format of the digital assistant under the corresponding task topic.

In other embodiments, in addition to the task topic setting information and plug-in information, the configuration information of one task topic may include at least one selected from the group consisting of: an indication of the selected language model, which language model is called to determine a reply to the user under the corresponding task topic; task topic guidance information, which is presented to the user after the corresponding task topic is selected; at least one recommendation question for the digital assistant, which is presented to the user for selection after the corresponding task topic is selected.

In response to receiving a selection operation for a first task topic in at least one task topic, the interaction between the user and the digital assistant can be performed in an interaction page between the user and the digital assistant based on configuration information of the first task topic, so as to implement the selection of the task topic (also called scene selection). For example, when the user wants to make schedule reservation through the digital assistant, the user can select a “schedule topic”. For another example, when the user wants to summarize the content of a document through the digital assistant, the user can select a “document topic”.

The digital assistant may have different processing for dialogues started by the user under different task topics. Specifically, according to the dialogues started by the user under different task topics, prompt information in the language model used by the digital assistant may be different, and the prompt information may include description information related to the task topic. For example, when the task topic is the “schedule topic”, the prompt information may include description information related to a schedule (such as function description information, parameter description information, etc. related to the schedule).

In addition, a processing tool (i.e., a plug-in) called by the digital assistant may be at least partially different for the dialogues started by the user under different task topics, and the processing tool can include a tool related to task topics. For example, when the task topic is the “schedule topic”, the processing tool called by the digital assistant may be a schedule plug-in. For another example, when the task topic is the “document topic”, the processing tool called by the digital assistant may be a document plug-in.

After the user selects the first task topic, the first task topic may be started in the interaction page of the digital assistant. For example, the interaction page may present a dividing line between the first task topic and a previous task topic, and in response to the user's interaction with the digital assistant in the first task topic, an identification of the first task topic is presented at an associated area of the dividing line, so as to distinguish different task topics (also called different scenes).

In the related art, the user needs to select a processing tool (i.e., a plug-in) by himself before the digital assistant starts the dialogue. However, the above-described method requires the user to have a certain understanding of different plug-ins, otherwise it is prone to errors. In the dialogue under the task topic, with the plug-in information configured in the task topic, a threshold for the user to use the digital assistant is lowered and operations of the user are simplified.

Through a selection of the task topic by the user, the digital assistant can process a natural language task in a targeted manner under the task topic selected by the user, so that the accuracy of responses by the digital assistant can be improved. However, the topics provided by the digital assistant can only be configured by developers of the digital assistant, which is difficult to meet the diversified man-machine dialogue needs of users.

In view of this, the present disclosure provides a method of information processing. This method is applied to the first server of the digital assistant. Specifically, the first server of the digital assistant generates a first message based on information indicated by a trigger request from a client of the digital assistant under a first task topic in response to the trigger request; then, the first server of the digital assistant sends the first message to a second server, to cause the second server to process the trigger request under the first task topic. The second server is a creator of the first task topic, and the first server receives a second message returned by the second server and sends the second message to the client of the digital assistant.

In this method, the first server of the digital assistant provides a man-machine dialogue service, the user triggers a request related to the man-machine dialogue under a task topic created by the second server (i.e., an external server), the first message generated by the first server of the digital assistant can be parsed by the second server, and the second server can process the trigger request and generate the second message, thereby realizing the man-machine dialogue. In this way, by generating the first message through the information indicated by different trigger requests, message transmission among the client of the digital assistant, the first server of the digital assistant and the external server can be realized, and the client of the digital assistant can be supported to realize the man-machine dialogue under the task topic created by the external server, thus meeting the diversified man-machine dialogue needs of users.

In order to facilitate the understanding of the technical solution provided by the embodiment of the present disclosure, the following description will be made with the attached drawings.

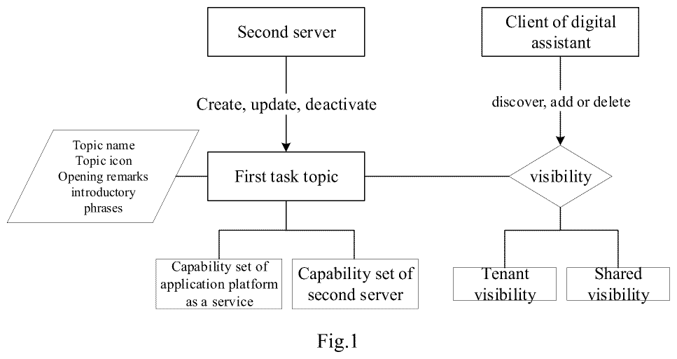

Referring to a schematic diagram of a task topic shown in FIG. 1, the second server may manage the first task topic, for example, the second server can create the first task topic, update the first task topic, or deactivate the first task topic. Specifically, the second server can manage a topic name, a topic icon, opening remarks, introductory phrases and other aspects of the first task topic.

The second server can implement natural language processing by using capability sets from different sources. The capability sets may include various capabilities related to the natural language processing. In some possible implementations, an application platform as a service (aPaaS) provides a capability set related to natural language processing, and the second server can create the first task topic by using the capability set provided by aPaaS. In other possible implementations, the second server has its own capability set related to natural language processing, and the second server can create the first task topic by using its own capability set.

After the second server creates the first task topic, the client of the digital assistant can discover, add or delete the first task topic. Discovering the first task topic can be understood as presenting the first task topic in a task topic page (for example, a page in a task topic store). By presenting the first task topic, the user can know the existence of the first task topic. Adding the first task topic can be understood as adding the first task topic as a topic of the client of the digital assistant, so that the user can have a man-machine dialogue under the first task topic. Deleting the first task topic can be understood as deleting the first task topic from the topics of the client of the digital assistant.

Further, the first task topic may have different dimensions of visibility. For example, the first task topic may have tenant visibility. In other words, the first task topic may be presented in clients of some tenants (that is, visible to clients of some tenants), but not in clients of other tenants (that is, invisible to clients of other tenants). In a process of creating the first task topic, the second server can limit a scope of use of the first task topic by configuring tenant visibility. As another example, the first task topic may have shared visibility. In other words, some clients can share the first task topic externally, while others cannot share the first task topic externally. In the process of creating the first task topic, the second server can improve the privacy and security of the first task topic by configuring the shared visibility.

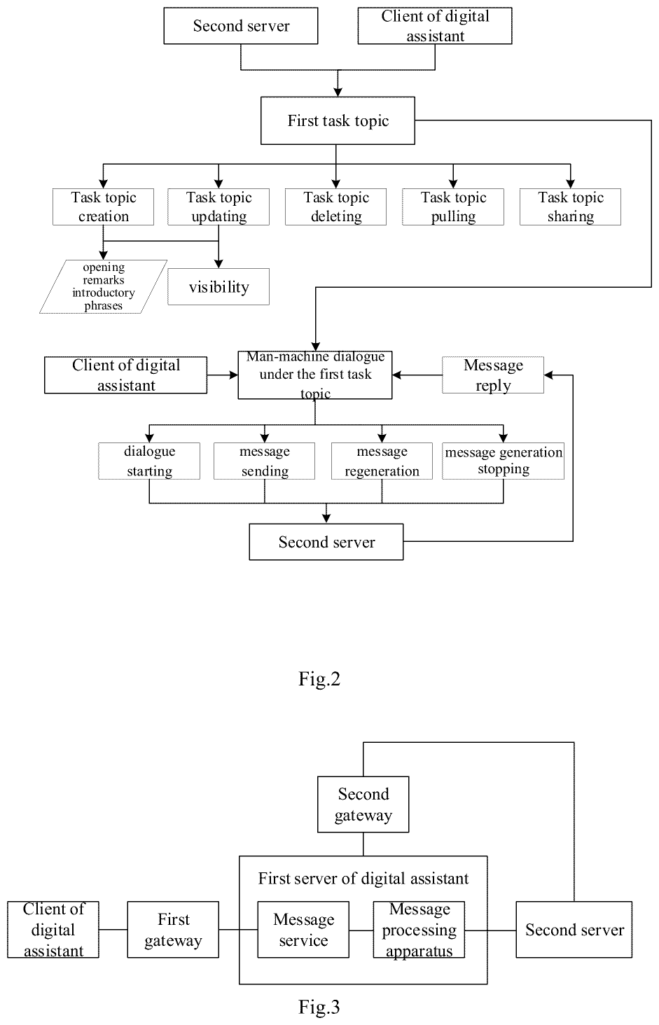

Referring to a schematic diagram of a dialogue under a task topic shown in FIG. 2, operations related to the first task topic may include task topic creation, task topic updating, task topic deletion, task topic pulling and task topic sharing. For example, the second server can perform task topic creation (including the creation of opening remarks and introductory phrases), task topic updating (including visibility updating) and task topic deletion, and the client of the digital assistant can perform task topic pulling and task topic sharing.

In the process of the man-machine dialogue under the first task topic, the client of the digital assistant can generate multiple trigger requests such as dialogue starting, message sending, message regeneration, message generation stopping, etc., and the second server can process the trigger requests generated by the client and generate messages for reply, thus realizing the man-machine dialogue.

Referring to the architectural schematic diagram of a system of information processing shown in FIG. 3, the system of information processing includes a client of a digital assistant, a first server of the digital assistant, and a second server. The second server is a creator of the first task topic. Specifically, the client of the digital assistant can trigger a request related to the man-machine dialogue under the first task topic, and the trigger request can be sent to the first server through a first gateway.

In some embodiments, the first server includes a message service and a message processing apparatus. The message service is used for managing messages, for example, the message service can manage messages generated during the man-machine dialogue between the client of the digital assistant and the first server. For another example, the message service can manage messages generated by other servers (such as an instant messaging server) in the same system (such as a business platform) as the first server. The message service receives the trigger request and sends the trigger request to the message processing apparatus, so that the message processing apparatus can generate the first message based on the information indicated by the trigger request.

The message processing apparatus can send the first message to the second server, and the second server processes the trigger request under the first task topic to generate a second message, and sends the second message to the first server through a second gateway, so that the first server can send the second message to the client to realize the man-machine dialogue.

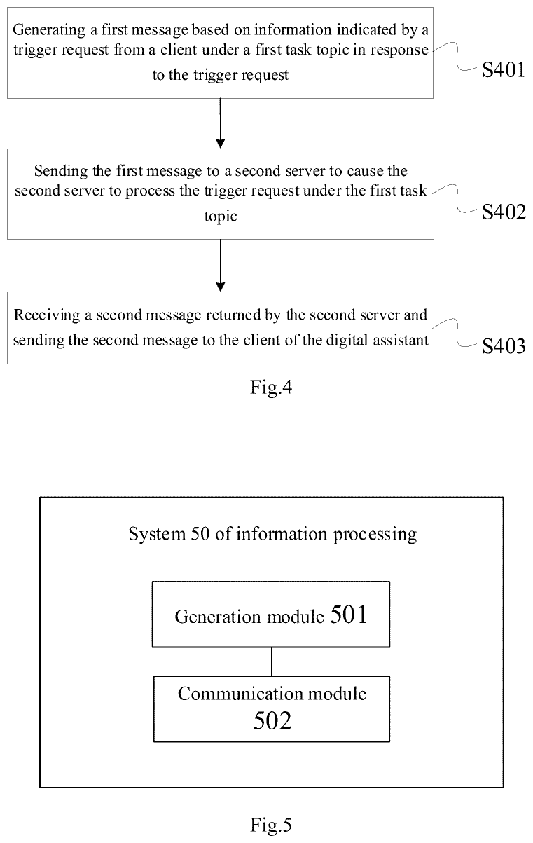

Referring to a flow diagram of a method of information processing provided by an embodiment of the present disclosure as shown in FIG. 4, the method can be applied to the first server of a digital assistant. The method specifically includes:

S401: generating a first message based on information indicated by a trigger request from a client under a first task topic in response to the trigger request.

In the embodiment of the present disclosure, the first server has a man-machine dialogue with the client of the digital assistant, so the first server can be understood as the server of the digital assistant.

The first server provides a variety of task topics, and the user can select from a variety of task topics according to actual needs, so as to carry out the man-machine dialogue under the selected task topic. In this embodiment of the present disclosure, the task topic selected by the user is the first task topic, and first task topic is created by the second server, that is, the second server is the creator of the first task topic.

Since the second server and the first server are different servers, the second server may also be called an external server and a third-party server. In other words, the first task topic is a task topic created by the external server.

The second server may create the task topic through an interface call. In concrete implementation, the first server of the digital assistant receives creation parameters sent by the second server through a second interface (application programming interface, API) in response to a call request from the second server for the second interface, and then the first server creates the first task topic according to the creation parameters.

The second interface may be an interface provided by the first server, and the second server can call the second interface and transmit the creation parameters through the second interface according to a protocol configured by the second interface, so that the first server can create the first task topic according to the creation parameters. In this way, the first server provides the second interface, and the external server is supported to create task topics in the first server, so that the types of task topics in the first server can be enriched.

The trigger request from the client of the digital assistant under the first task topic can be understood as a request related to the first task topic triggered by the client of the digital assistant, and the trigger request can indicate the trigger type. For example, when the trigger request is that the client of the digital assistant starts the first task topic, the trigger type may be dialogue starting. For another example, when the trigger request is that the client of the digital assistant sends a third message, the trigger type may be message sending. For still another example, when the trigger request is that the client of the digital assistant triggers a regeneration control, the trigger type may be message regeneration. For yet another example, when the trigger request is that the client of the digital assistant triggers a generation stopping control, the trigger type may be message generation stopping.

In the embodiment of the present disclosure, different trigger types may correspond to different templates. The template (also called a structure) may include a plurality of fields related to the trigger type, and these fields characterize the content that needs to be delivered to the second server under this trigger type. Moreover, the second server also stores templates corresponding to different trigger types.

The first server may determine the trigger type indicated by the trigger request according to the trigger request, and process the trigger request based on the template corresponding to the trigger type to generate the first message. In concrete implementation, the first server can parse the trigger request, extract parameter information from the trigger request, for example, extract field values corresponding to multiple fields related to the trigger types in the template, and fill them into the template, thus generating the first message.

Since the first message is generated based on the template of the trigger type indicated by the trigger request, the first message may also be called an event corresponding to the trigger request. The first message under different trigger requests will be described below.

In some embodiments, the trigger request is that the client starts the first task topic. The first server generates a first message based on information indicated by a starting request in response to the starting request for the first task topic.

The starting request for the first task topic can be understood as a request from the client of the digital assistant to enter a dialogue page of the first task topic. In view of that when the trigger request is that the client starts the first task topic, the second server can send the pre-configured content such as opening remarks and introductory phrases to the client to enable the user to know the first task topic and facilitate the user to have a better man-machine dialogue under the first task topic, the first server can generate the first message for the trigger request, wherein the first message includes fields related to the first task topic.

It can be understood that the second server needs to send the corresponding pre-configured content according to the task topic that the client is currently entering. Therefore, the first message sent by the first server to the second server may include fields related to the first task topic.

As will be explained with specific examples, in some possible implementations, a template of the trigger type indicated by the starting request is as follows:

| type AINewScene struct { | |
|---|---|
| Sender | *Sender ‘json:″ sender″‘ |
| AIContext | *MyAIContext ‘json:″ ai_context″‘ |

| } | |
|---|---|
| type AIContext struct { | |
| SessionID | string ‘json:″ session_id″‘ |
| SceneID | string ‘json:″ scene_id″‘ |
| VerifyToken | string ‘json:″ verify_token″‘ |

}

where, SceneID is a field related to the first task topic, and the field represents an identification of the first task topic. Further, the first message may also include a field “Sender” for indicating the sender of the trigger request, a field “SessionID” for indicating a current session identification, and a field “VerifyToken” for message verification.

In some embodiments, the trigger request is that the client of the digital assistant sends a third message. The first server acquires a third message sent by the client of the digital assistant in response to a message sending request under the first task topic, and then, the first server can generate, according to the third message, a first message based on information indicated by the message sending request.

The message sending request under the first task topic can be understood as a request from the client of the digital assistant to send natural language content, which natural language content can be inputted by the user through the client of the digital assistant. In view of that when a trigger request is that the client sends a third message, the second server may send a reply content for the third message to the client to complete a round of dialogue, the first server can generate a first message for the trigger request, where the first message includes fields related to the first task topic and fields related to the third message, and a message structure indicated by the fields related to the third message is consistent with a message structure of the second server.

It can be understood that the second server needs to send the reply content of the third message according to the task topic that the client is currently entering and the third message sent by the client. Therefore, the first message sent by the first server to the second server may include fields related to the first task topic and fields related to the third message. Further, in the first message sent to the second server, the third message sent by the client is stored in a message structure of the second server, so that the second server can extract the content of the third message by parsing the first message, which facilitates realizing the man-machine dialogue later.

As will be explained with specific examples, in some possible implementations, a template of the trigger type indicated by the message sending request is as follows:

| type MessageReceive struct { | |
|---|---|
| Sender | *Sender ‘json:″ sender″‘ |
| Message | *Message ‘json:″ message″‘ |
| AIContext | *MyAIContext ‘json:″ ai_context″‘ |
| } | |
| type AIContext struct { | |
| SessionID | string ‘json:″ session_id″‘ |
| SceneID | string ‘json:″ scene_id″‘ |
| VerifyToken | string ‘json:″ verify_token″‘ |

}

where, SceneID is a field related to the first task topic, and the field represents an identification of the first task topic; and Message is a field related to the third message, and a message structure indicated by this field is consistent with the message structure of the second server. Further, the first message may also include a field “Sender” for indicating the sender of the trigger request, a field “SessionID” for indicating a current session identification, and a field “VerifyToken” for message verification.

Similarly, the trigger request may also be that the client of the digital assistant triggers the regeneration control, or that the client of the digital assistant triggers the generation stopping control, and the first server can generate the first message based on information indicated by the message regeneration request or information indicated by the message generation stopping request, so that the second server can process different events under the first task topic.

In addition, in some embodiments, the client of the digital assistant can also actively subscribe to the first task topic. After the client actively subscribes to the first task topic, the second server can actively send a message to the client when the client does not send the third message. At this time, the trigger request may be that the client reaches the set sending time, and the first server can generate the first message based on information indicated by an active message sending request.

In some embodiments, in view of that the trigger request from the client is to be processed by the second server, in order to ensure the security of messaging, the first server can check the message. In concrete implementation, the first server generates a first verification token corresponding to the trigger request from the client of the digital assistant under the first task topic in response to the trigger request, and then, the first server generates a first message based on the first verification token and a template of the trigger type indicated by the trigger request.

By carrying the first verification token in the first message generated by the first server (that is, the “VerifyToken” field above), message verification can be performed when the second message returned by the second server is subsequently received. The first verification token may be generated by a unique generator, thereby ensuring the uniqueness of the first verification token. After generating the first verification token, the first server can bind the first verification token with information related to the trigger request, for example, bind the first verification token with one or more of the task topic identification (i.e., the first task topic), the trigger type, the trigger request, the current session identification and the creator of the task topic (i.e., the second server). In this way, in the subsequent message verification process, the verification token can be used as an index to search information related to the trigger request, and then verification is carried out.

S402: sending the first message to a second server to cause the second server to process the trigger request under the first task topic.

Since the first task topic is created by the second server, the second server needs to process the trigger request under the first task topic, and then generates the second message.

Specifically, when the trigger request from the client of the digital assistant under the first task topic is the starting request for the first task topic, the second message may include a content pre-configured by the second server. For example, the pre-configured content can be welcome words, introductory phrases or opening remarks, or the like. In this way, when the client of the digital assistant starts the first task topic, it can present welcome words, introductory phrases or opening remarks to the user.

When the trigger request from the client of the digital assistant under the first task topic is the message sending request, the second message may include a reply content for the third message sent by the client of the digital assistant. In this way, when the user sends the natural language content under the first task topic, the reply content of the natural language content can be presented to the user, thus realizing the man-machine dialogue.

The second server can process the third message by means of the language model. In concrete implementation, the second server can determine the third message sent by the client of the digital assistant according to the first message, and then call the language model corresponding to the first task topic to cause the language model to process the third message and return the reply content for the third message, and the second server can generate a second message according to the reply content.

The language model usually has a natural language processing capability and can process natural language tasks. For example, the language model may be a deep learning model trained using text data. The language model corresponding to the first task topic can be understood as a language model that can be used to process the trigger request under the first task topic, for example, a language model in which the prompt information includes description information related to the first task topic.

Since the message structure of the third message stored in the first message is the same as that of the second server, the second server can extract the third message from the first message, use the language model to perform natural language processing on the third message, and identify an intention expressed by the third message, and then generate the reply content for the third message. In this way, the second server can complete the processing of the trigger request under the first task topic and generate the second message.

S403: receiving a second message returned by the second server and sending the second message to the client of the digital assistant.

After the second server completes the processing of the trigger request under the first task topic and generates the second message, since the second server cannot directly send the second message to the client of the digital assistant, the second server can first send the second message to the first server, and then the first server sends the second message to the client of the digital assistant, thereby displaying the content corresponding to the second message in the client of the digital assistant.

The second server can send the second message through an interface call. In specific implementation, the first server may receive a second message sent by the second server through a first interface in response to a call request from the second server for the first interface.

The first interface may be an interface provided by the first server of the digital assistant, and the second server can call the first interface to transmit the second message through the first interface in a format supported by a protocol configured by the first interface, so as to deliver the second message to the first server.

In some embodiments, the first server of the digital assistant can provide first interfaces in two different transmission modes, namely, a streaming mode and a non-streaming mode. Specifically, the second server can select a required transmission mode according to the actual demand, such as the trigger request or a format of the second message, and call the first interface corresponding to the transmission mode, so as to deliver the second message to the first server through a streaming or non-streaming mode.

Further, when the second message is used for message updating, the first interface may also be an interface for message updating. The second server can deliver the second message (such as a second message presented as a card message) to the first server by calling the first interface, so as to update the message in the client of the digital assistant.

In some embodiments, the first message includes a first verification token corresponding to the trigger request, and at this time, the first server can perform message verification. In concrete implementation, the first server receives the second message returned by the second server and acquires a second verification token in the second message, and the first server can send the second message to the client of the digital assistant in response to verification information indicated by the second verification token meeting a verification condition of the first verification token.

That is to say, the second message generated by the second server carries the second verification token, and the first server can search corresponding verification information according to the second verification token, such as one or more of the task topic identification, the trigger type, the trigger request, the current session identification and the creator of the task topic bound with the second verification token.

When the first server generates the first message, the first message carries the first verification token and the first verification token is bound with the information related to the trigger request, therefore, the first server can compare the searched verification information with the information bound with the first verification token to realize message verification; when the verification information meets the verification condition of the first verification token, for example, when the verification information indicated by the second verification token is the same as the information related to the trigger request bound by the first verification token, the first server can judge that the second verification token and the first verification token are the same verification token, the verification passes, and the first server can send the second message to the client of the digital assistant.

In this way, through the verification tokens, the first server can verify whether the second message sent by the second server is a message generated by the second server after processing the trigger request under the first task topic, so as to ensure that the second message corresponds to the first message and avoid sending wrong messages to the client.

Further, the verification token may also be configured with an expiration mechanism. Specifically, the verification condition of the first verification token may also include whether the first verification token is used for the first time, and if the first verification token is not used for the first time, the verification fails. In other words, after the first server can judge that the second verification token and the first verification token are the same verification token, if the first verification token is not used for the first time, it indicates that the second server has sent the second message for the current trigger request to the client of the digital assistant through the first server; in order to prevent the second server from sending messages to the client repeatedly, the verification fails at this time, and the first server will not send the second message to the client of the digital assistant, thus reducing excessive disturbance from the second server to the user.

In addition, the verification token may also be configured with a bottom-taking mechanism. Specifically, the verification condition of the first verification token may also include whether the first verification token is used within a set usage period, and when the first verification token is not used within the set usage period, the verification fails. In other words, after the first server can judge that the second verification token and the first verification token are the same verification token, if the first verification token is not used within the set service period, it indicates that the second server has not finished processing the trigger request for the first task topic for a long time; in order to prevent the user from waiting for a long time, the first server will not send the second message to the client of the digital assistant at this time, thus improving the efficiency of the man-machine dialogue.

In this embodiment of the present disclosure, since the second server only creates the first task topic in the first server and essentially the client still performs a man-machine dialogue with the first server, the sender of the second message received by the client of the digital assistant should be the first server. In specific implementation, the first server can modify fields related to the sender in the second message, the sender indicated by the modified second message being the first server of the digital assistant, and send the modified second message to the client of the digital assistant.

In this way, in the process of the man-machine dialogue between the first server and the client, no matter whether the client of the digital assistant triggers the request under the task topic created by the first server or under the task topic created by the external server, the sender of the response (that is, the second message) received by the client is the first server of the digital assistant, so that the man-machine dialogue under a richer and more customized task topic can be realized without changing a logic of the man-machine dialogue between the first server and the client.

Based on the above description, an embodiment of the present disclosure provides a method of information processing. This method is applied to the first server of the digital assistant. Specifically, the first server of the digital assistant generates a first message based on information indicated by a trigger request from a client of the digital assistant under a first task topic in response to the trigger request; then, the first server of the digital assistant sends the first message to a second server, to cause the second server to process the trigger request under the first task topic, where the second server is a creator of the first task topic, and the first server receives a second message returned by the second server and sends the second message to the client of the digital assistant.

In this method, the first server of the digital assistant provides a man-machine dialogue service, the user triggers a request related to the man-machine dialogue under a task topic created by the second server (i.e., an external server), the first message generated by the first server of the digital assistant can be parsed by the second server, and the second server can process the trigger request and generate the second message, thereby realizing the man-machine dialogue. In this way, by generating the first message through the information indicated by different trigger requests, message transmission among the client of the digital assistant, the first server of the digital assistant and the external server can be realized, and the client of the digital assistant can be supported to realize the man-machine dialogue under the task topic created by the external server, thus meeting the diversified man-machine dialogue needs of users.

The method of information processing provided by the embodiment of the present disclosure is described in detail with reference to FIG. 1 to FIG. 4 above, and the system and the device provided by embodiments of the present disclosure will be described with reference to the attached drawings.

Referring to the structural schematic diagram of the system of information processing shown in FIG. 5, the system 50 includes:
a generation module 501 configured to generate a first message based on information indicated by a trigger request from a client of the digital assistant under a first task topic in response to the trigger request; and
a communication module 502 configured to send the first message to a second server to cause the second server to process the trigger request under the first task topic, the second server being a creator of the first task topic,
the communication module 502 also being configured to receive a second message returned by the second server and send the second message to the client of the digital assistant.

In some possible implementations, the generation module 501 is specifically configured to:
determine a trigger type indicated by the trigger request according to the trigger request; and
generate a first message based on a template corresponding to the trigger type.

In some possible implementations, the generation module 501 is specifically configured to:
generate a first message based on information indicated by a starting request in response to the starting request from the digital assistant client for the first task topic, the first message including fields related to the first task topic.

In some possible implementations, the generation module 501 is specifically configured to:
acquire a third message sent by the client of the digital assistant in response to a message sending request from the client of the digital assistant under the first task topic; and
generate, according to the third message, a first message based on information indicated by the message sending request, wherein the first message includes fields related to the first task topic and fields related to the third message, and a message structure indicated by the fields related to the third message is consistent with a message structure of the second server.

In some possible implementations, the communication module 502 is specifically configured to:
receive a second message sent by the second server through a first interface in response to a call request from the second server for the first interface.

In some possible implementations, the generation module 501 is specifically configured to:
generate a first verification token corresponding to the trigger request in response to the trigger request from the client of the digital assistant under the first task topic; and
generate the first message based on the first verification token and the information indicated by the trigger request.

In some possible implementations, the first message includes a first verification token corresponding to the trigger request, the communication module 502 being specifically configured to:
receive a second message returned by the second server and acquire a second verification token in the second message; and
send the second message to the client of the digital assistant in response to verification information indicated by the second verification token meeting a verification condition of the first verification token.

In some possible implementations, the system 50 also includes a modification module, the modification module being configured to:
modify fields related to a sender in the second message, wherein the sender indicated by the modified second message is the first server of the digital assistant; and
the communication module 502 is specifically configured to:
send the modified second message to the client of the digital assistant.

In some possible implementations, the trigger request from the client of the digital assistant under the first task topic is the starting request for the first task topic, and the second message includes a content pre-configured by the second server; and
the trigger request from the client of the digital assistant under the first task topic is the message sending request, and the second message includes a reply content for the third message sent by the client of the digital assistant.

In some possible implementations, the trigger request from the client of the digital assistant under the first task topic is the message sending request, and the second server processing the trigger request under the first task topic includes:
determining, by the second server, the third message sent by the client of the digital assistant according to the first message;
calling, by the second server, a language model corresponding to the first task topic to cause the language model to process the third message and return the reply content for the third message;
generating, by the second server, the second message according to the reply content.

In some possible implementations, the second server creates the first task topic by the following steps:
receiving creation parameters sent by the second server through a second interface in response to a call request from the second server for the second interface; and
creating the first task topic according to the creation parameters.

In some possible implementations, the first task topic is configured with corresponding configuration information to execute a corresponding type of task, and the configuration information includes at least one selected from the group consisting of: task topic setting information and plug-in information, wherein the task topic setting information is used for describing information related to the corresponding task topic, and the plug-in information indicates at least one plug-in configured to execute a task under the corresponding task topic.

The system 50 of information processing according to the embodiment of the present disclosure may correspond to the method described in the embodiment of the present disclosure, and the above and other operations and/or functions of various modules/units of the system 50 of information processing are respectively used to implement the corresponding flows of the methods in the embodiments shown in FIG. 4, which are omitted here for brevity.

An embodiment of the present disclosure also provides an electronic device. The electronic device is specifically configured to implement the functions of the system 50 of information processing in the embodiment shown in FIG. 5.

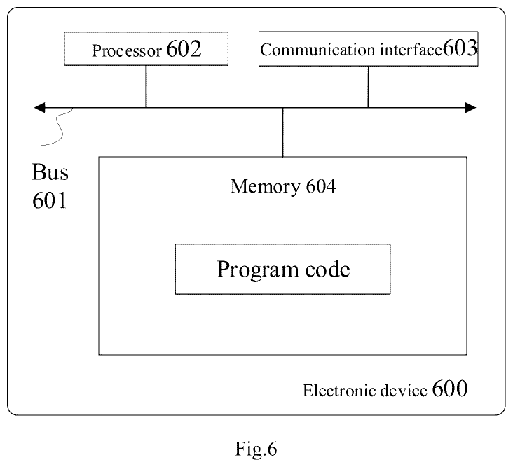

FIG. 6 provides a structural schematic diagram of an electronic device 600. As shown in FIG. 6, the electronic device 600 includes a bus 601, a processor 602, a communication interface 603 and a memory 604. The processor 602, the memory 604 and the communication interface 603 communicate with one another through the bus 601.

The bus 601 may be a peripheral component interconnect (PCI) bus or an extended industry standard architecture (EISA) bus, etc. The bus can be divided into an address bus, a data bus, a control bus, etc. For convenience of representation, only one thick line is used in FIG. 6, but it does not mean that there is only one bus or one type of bus.

The processor 602 may be any one or more of processors such as a central processing unit (CPU), a graphics processing unit (GPU), a micro-processor (MP) or a digital signal processor (DSP).

The communication interface 603 is used for external communication. For example, the communication interface 603 may be used for communicating with a terminal.

The memory 604 may include a volatile memory, such as a random access memory (RAM). The memory 604 may also include a non-volatile memory, such as a read-only memory (ROM), a flash memory, a hard disk drive (HDD) or a solid state drive (SSD).

An executable code is stored in the memory 604, and the processor 602 executes the executable code to perform the aforementioned method of information processing.

Specifically, in a case of implementing the embodiment shown in FIG. 5, and in a case that various modules or units of the system 50 of information processing described in the embodiment of FIG. 5 are implemented by software, the software or program codes required for executing the functions of each module/unit in FIG. 5 may be partially or completely stored in the memory 604. The processor 602 executes the program codes corresponding to the units stored in the memory 604 and executes the aforementioned method of information processing.

An embodiment of the present disclosure also provides a non-transitory computer-readable storage medium. The computer-readable storage medium may be any available medium that a computing device can store or a data storage device such as a data center containing one or more available media. The available medium may be a magnetic medium (such as a floppy disk, a hard disk, a magnetic tape), an optical medium (such as DVD), or a semiconductor medium (such as a solid state hard disk) and the like. The non-transitory computer-readable storage medium includes instructions that instruct the computing device to perform a text processing method described above as applied to the system 50 of information processing.

An embodiment of the present disclosure also provides a computer program product, the computer program product including one or more computer instructions. When the computer instructions are loaded and executed on the computing device, the flows or functions according to the embodiment of the present disclosure are generated in whole or in part.

The computer instructions may be stored in a computer-readable storage medium or transmitted from one computer-readable storage medium to another. For example, the computer instructions may be transmitted from one website, computer or data center to another website, computer or data center in a wired (such as a coaxial cable, an optical fiber, a digital subscriber line (DSL)) or wireless (such as infrared, wireless, microwave, etc.) manner.

When the computer program product is executed by a computer, the computer executes any one of the aforementioned methods of information processing. The computer program product can be a software installation package and can be downloaded and executed on a computer if any one of the aforementioned methods of information processing is needed.

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

It should be noted that the various embodiments in this specification are described in a progressive manner, with each embodiment focusing on its differences from other embodiments. The same and similar parts between the embodiments can be referred to each other. For the system or device disclosed in the embodiments, as it corresponds to the method disclosed in the embodiments, the description is relatively simple. For relevant information, the description for the method is referred.

It should be understood that in the present disclosure, “at least one (item)” refers to one or more, and “multiple” refers to two or more. “And/or” is used to describe the association relationship between related objects, indicating that there can be three types of relationships. For example, “A and/or B” can represent: only A, only B, or both A and B, where A and B can be singular or multiple. The character “/” generally indicates that the associated object before and after is an “or” relationship. “At least one (item) of the following” or similar expressions refers to any combination of these items, including any combination of single (item) or multiple (items). For example, at least one (item) of a, b, or c can represent: a, b, c, “a and b”, “a and c”, “b and c”, or “a and b and c”, where a, b, c can be a single or multiple.

It should also be noted that, relational terms herein such as first and second are only used to distinguish one entity or operation from another, and do not necessarily require or imply any actual relationship or order between these entities or operations. Moreover, the terms “including”, “containing”, or any other variation thereof are intended to encompass non-exclusive inclusion, such that a process, method, item, or device including a series of elements includes not only those elements, but also other elements not explicitly listed, or elements inherent to such process, method, item, or device. Without further limitations, the element defined by the statement “including one . . . ” does not exclude the existence of other same elements in the process, method, item, or device that includes the element.

The steps of the method or algorithm described in the embodiments disclosed herein can be directly implemented using hardware, software modules executed by processors, or a combination of both. Software modules can be stored in a random access memory (RAM), an internal memory, a read-only memory (ROM), an electrically programmable ROM, an electrically erasable programmable ROM, a register, a hard drive, a removable disk, CD ROM, or any other form of storage medium.

The above description of the disclosed embodiments enables those skilled in the art to implement or use the disclosure. Various modifications to these embodiments will be apparent to those skilled in the art, and the general principles defined herein can be implemented in other embodiments without departing from the spirit or scope disclosure. Therefore, the disclosure will not be limited to the embodiments illustrated herein but will be within the widest scope consistent with the principles and novel features of the disclosure.

1. A method of information processing, applied to a first server of a digital assistant, the method comprising:
generating a first message based on information indicated by a trigger request from a client of the digital assistant under a first task topic in response to the trigger request;
sending the first message to a second server to cause the second server to process the trigger request under the first task topic, the second server being a creator of the first task topic; and
receiving a second message returned by the second server and sending the second message to the client of the digital assistant.

2. The method according to claim 1, wherein generating the first message based on the information indicated by the trigger request comprises:
determining a trigger type indicated by the trigger request according to the trigger request; and
generating a first message based on a template corresponding to the trigger type.

3. The method according to claim 1, wherein generating the first message based on the information indicated by the trigger request from the client of the digital assistant under the first task topic in response to the trigger request comprises:
generating the first message based on information indicated by a starting request from the client of the digital assistant for the first task topic in response to the starting request, the first message comprising fields related to the first task topic.

4. The method according to claim 1, wherein generating the first message based on information indicated by the trigger request from the client of the digital assistant under the first task topic in response to the trigger request comprises:
acquiring a third message sent by the client of the digital assistant in response to a message sending request from the client of the digital assistant under the first task topic; and
generating, according to the third message, a first message based on information indicated by the message sending request, wherein the first message comprises fields related to the first task topic and fields related to the third message, and a message structure indicated by the fields related to the third message is consistent with a message structure of the second server.

5. The method according to claim 1, wherein receiving the second message returned by the second server comprises:
receiving a second message sent by the second server through a first interface in response to a call request from the second server for the first interface.

6. The method according to claim 1, wherein generating the first message based on information indicated by the trigger request from the client of the digital assistant under the first task topic in response to the trigger request comprises:
generating a first verification token corresponding to the trigger request in response to the trigger request from the client of the digital assistant under the first task topic; and
generating the first message based on the first verification token and the information indicated by the trigger request.

7. The method according to claim 1, wherein the first message comprises a first verification token corresponding to the trigger request, and receiving the second message returned by the second server and sending the second message to the client of the digital assistant comprises:
receiving a second message returned by the second server and acquiring a second verification token in the second message; and
sending the second message to the client of the digital assistant in response to verification information indicated by the second verification token meeting a verification condition of the first verification token.

8. The method according to claim 1, wherein after receiving the second message returned by the second server, the method further comprises:
modifying fields related to a sender in the second message, wherein the sender indicated by the modified second message is the first server of the digital assistant; and
sending the second message to the client of the digital assistant comprises:
sending the modified second message to the client of the digital assistant.

9. The method according to claim 1, wherein the trigger request from the client of the digital assistant under the first task topic is a starting request for the first topic, the second message comprises a content pre-configured by the second server; and
the trigger request from the client of the digital assistant under the first task topic is the message sending request, and the second message comprises a reply content for a third message sent by the client of the digital assistant.

10. The method according to claim 1, wherein the trigger request from the client of the digital assistant under the first task topic is the message sending request, and the second server processing the trigger request under the first task topic comprises:
determining, by the second server, a third message sent by the client of the digital assistant according to the first message;
calling, by the second server, a language model corresponding to the first task topic to cause the language model to process the third message and return a reply content for the third message;
generating, by the second server, the second message according to the reply content.

11. The method according to claim 1, wherein the second server creates the first task topic through the following steps:
receiving creation parameters sent by the second server through a second interface in response to a call request from the second server for the second interface; and
creating the first task topic according to the creation parameters.

12. The method according to claim 1, wherein the first task topic is configured with corresponding configuration information to execute a corresponding type of task, and the configuration information comprises at least one selected from the group consisting of: task topic setting information and plug-in information, wherein the task topic setting information is used for describing information related to the corresponding task topic, and the plug-in information indicates at least one plug-in configured to execute a task under the corresponding task topic.

13. The method according to claim 2, wherein the first task topic is configured with corresponding configuration information to execute a corresponding type of task, and the configuration information comprises at least one selected from the group consisting of: task topic setting information and plug-in information, wherein the task topic setting information is used for describing information related to the corresponding task topic, and the plug-in information indicates at least one plug-in configured to execute a task under the corresponding task topic.

14. The method according to claim 3, wherein the first task topic is configured with corresponding configuration information to execute a corresponding type of task, and the configuration information comprises at least one selected from the group consisting of: task topic setting information and plug-in information, wherein the task topic setting information is used for describing information related to the corresponding task topic, and the plug-in information indicates at least one plug-in configured to execute a task under the corresponding task topic.

15. The method according to claim 4, wherein the first task topic is configured with corresponding configuration information to execute a corresponding type of task, and the configuration information comprises at least one selected from the group consisting of: task topic setting information and plug-in information, wherein the task topic setting information is used for describing information related to the corresponding task topic, and the plug-in information indicates at least one plug-in configured to execute a task under the corresponding task topic.

16. The method according to claim 5, wherein the first task topic is configured with corresponding configuration information to execute a corresponding type of task, and the configuration information comprises at least one selected from the group consisting of: task topic setting information and plug-in information, wherein the task topic setting information is used for describing information related to the corresponding task topic, and the plug-in information indicates at least one plug-in configured to execute a task under the corresponding task topic.

17. The method according to claim 6, wherein the first task topic is configured with corresponding configuration information to execute a corresponding type of task, and the configuration information comprises at least one selected from the group consisting of: task topic setting information and plug-in information, wherein the task topic setting information is used for describing information related to the corresponding task topic, and the plug-in information indicates at least one plug-in configured to execute a task under the corresponding task topic.

18. The method according to claim 7, wherein the first task topic is configured with corresponding configuration information to execute a corresponding type of task, and the configuration information comprises at least one selected from the group consisting of: task topic setting information and plug-in information, wherein the task topic setting information is used for describing information related to the corresponding task topic, and the plug-in information indicates at least one plug-in configured to execute a task under the corresponding task topic.

19. An electronic device, comprising: a processor and a memory;
the processor is configured to execute instructions stored in the memory, so as to cause the electronic device to execute a method of information processing, and the method comprising:
generating a first message based on information indicated by a trigger request from a client of a digital assistant under a first task topic in response to the trigger request;
sending the first message to a second server to cause the second server to process the trigger request under the first task topic, the second server being a creator of the first task topic; and
receiving a second message returned by the second server and sending the second message to the client of the digital assistant.

20. A non-transitory computer-readable storage medium, comprising instructions that instruct an electronic device to execute a method of information processing, and the method comprises:
generating a first message based on information indicated by a trigger request from a client of a digital assistant under a first task topic in response to the trigger request;
sending the first message to a second server to cause the second server to process the trigger request under the first task topic, the second server being a creator of the first task topic; and
receiving a second message returned by the second server and sending the second message to the client of the digital assistant.
